(19) United States
(12) Patent Application Publication
(10) Pub. No.: US 2007/0097052 A1
(43) Pub. Date: May 3, 2007

(54) LIQUID CRYSTAL DISPLAY DEVICE

(75) Inventor: Takeshi SASAKI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC LCD TECHNOLOGIES, LTD

(21) Appl. No.: 11/553,879

(22) Filed: Oct. 27, 2006

(30) Foreign Application Priority Data
Oct. 28, 2005 (JP) 315092/2005

(51) Int. Cl. G09G 3/36

(52) U.S. Cl. 345/92

(57) ABSTRACT

In a LCD device, at least two switching elements are connected to each of the pixel electrodes. A first switching element out of the two switching elements is connected to a first drain line which supplies display signals having a positive polarity. A second switching element out of the two switching elements is connected to a second drain line which supplies display signals having a negative polarity. A gate of the first switching element is connected to a corresponding one of odd-numbered gate lines, and a gate of the second switching element is connected to a corresponding one of even-numbered gate lines. The gate-scan driving circuit selectively drives the odd-numbered gate lines and the even-numbered gate lines, thereby directions of electric fields acting upon liquid crystals are inverted without changing the polarities of the display signals.

### BACKGROUND OF THE INVENTION

1. Field of the Invention

The present invention relates to a liquid crystal display device. Particularly, the present invention relates to a liquid crystal display device which reduces power consumption.

2. Description of the Related Art

As a display device of an audio-visual (AV) machine and an office automation (OA) machine, a liquid crystal display (LCD) device has been widely used because of its advantages including a thin thickness, a light weight, a low power consumption and the like.

In other words, a display device for a personal computer, a television and the like, and a display device for an electronic calculator, a mobile television, a mobile phone, a mobile facsimile and the like are desired to be small-sized and lightweight. Additionally, these devices are desired to be low in power consumption because, when they are carried, they are needed to be battery-operated.

As a display device low in power consumption, for example, an LCD device and the like are known.

That is, it is also well recognized that an LCD device is the most suitable for meeting a requirement for low power consumption. On the other hand, an LCD device is also desired to become large-sized and to have a higher definition.

Typical conventional LCD devices are disclosed in, for example, Japanese Patent Laid-open Official Gazette No. 2003-315766 (FIG. 1) and Japanese Patent Laid-open Official Gazette No. 2003-255907 (FIGS. 1 and 2), respectively.

In an active-matrix type LCD device as one of typical conventional LCD devices, pixels are arranged in a matrix. In addition, each of the pixels includes one switching element. In the active-matrix LCD device, this switching element is connected to an address line, and a display signal is supplied from a signal line under the control of the switching element.

In FIG. 1A, a schematic diagram illustrating an outline of the active-matrix type LCD device is shown. In this case, in the active-matrix type LCD device, pixels arranged in one column correspond to one signal line extending along that same column. Furthermore, in the active-matrix type LCD device, for signal lines arranged in a direction of rows, signal line driving circuits are respectively arranged in that same direction.

In the active-matrix type LCD device, supply of a display signal to one pixel is performed by way of one signal line and one signal line driving circuit.

Additionally, LCD elements in the prior art include one thin-film transistor (TFT) per pixel, and one gate wiring and one signal wiring correspond to the TFT. In addition, the positive or negative polarity of a voltage supplied to the signal wiring through which the aforementioned TFT supplies voltage to a pixel electrode is inverted to a common voltage, on a column to column basis. Positive and negative potentials relative to the common voltage are supplied to, and retained in, the pixel electrode alternately on a frame to frame basis (refer to FIG. 2).

In a case where the conventional LCD devices described in Japanese Patent Laid-open Official Gazette No. 2003-315766 and Japanese Patent Laid-open Official Gazette No. 2003-255907 are made larger in size, however, a parasitic capacitance becomes larger which is generated between a signal line and a gate line, between a signal line and a common electrode, between a signal line and a pixel electrode, or the like. Therefore, a time constant, which is defined by a signal line capacitance and a wiring resistance, becomes larger.

Thereby, the rise time of signal lines is delayed, and there is a possibility that display signal supply to pixels cannot be sufficiently performed.

Additionally, in a case where the conventional LCD devices are made higher in definition, the number of pixels driven within one field period is increased. For this reason, a write time per pixel becomes shorter, thereby voltage supply to the pixels becomes insufficient.

On the other hand, in a case where horizontal line inversion or dot inversion is performed, a polarity inversion frequency of signal line driving circuits becomes higher. As a result, a power consumption is increased.

### SUMMARY OF THE INVENTION

The present invention was made for the purpose of solving the above-described problems, and an object of the present invention is to provide a liquid crystal display device free from the aforementioned problems.

In order to achieve the aforementioned object, a liquid crystal display device of the present invention includes: a plurality of drain lines; a plurality of gate lines intersecting these drain lines; and switching elements formed in vicinities of corresponding ones of intersections of the drain lines and the gate lines. Furthermore, the liquid crystal display device of the present invention includes: an array substrate including pixel electrodes and a pixel region constituted of the pixel electrodes, the pixel electrodes being arranged in a matrix, and each of the pixel electrodes being connected to one of the two terminals of each of the switching elements, a counter substrate placed to face the array substrate; and a liquid crystal layer interposed between the array substrate and the counter substrate.

The above described liquid crystal display device of the present invention further includes a signal output circuit which outputs display signals corresponding to display data to the drain lines, and a gate-scan driving circuit which sequentially scans the gate lines in every scanning frame period.

While having the above described constitution, the liquid crystal display device of the present invention has at least two of the switching elements connected to each of the pixel electrodes. In addition, in the liquid crystal display device of the present invention, the other terminal of a first switching element out of the two switching elements is connected to an odd-numbered one of the drain lines, which supplies first display signals having a positive polarity. The other terminal of a second switching element out of the two switching elements is connected to an even-numbered one of the drain lines, which supplies second display signals having a negative polarity. Moreover, in the liquid crystal display device of the present invention, an odd-numbered one of the gate lines is connected to a control terminal of the first switching element, and an even-numbered one of the gate lines is connected to a control terminal of the second switching element.

In addition, the gate-scan driving circuit of the liquid crystal display device of the present invention has a configuration where: the gate-scan driving circuit selectively drives the odd-numbered ones of the gate lines and the even-numbered ones of the gate lines, and thereby inverts directions of electric fields acting upon the liquid crystal layer without changing the polarities of the display signals.

On the other hand, another liquid crystal display device of the present invention includes: a plurality of drain lines; a plurality of gate lines intersecting the drain lines; and switching elements formed in vicinities of corresponding ones of intersections of the drain lines and the gate lines. Moreover, the liquid crystal display device of the present invention includes: an array substrate including pixel electrodes and a pixel region constituted of the pixel electrodes, the pixel electrodes being arranged in a matrix of m rows (where m represents a positive integer) and n columns (where n represents a positive integer), and each of the pixel electrodes being connected to one of the two terminals of each of the switching elements; a counter substrate placed to face the array substrate; and a liquid crystal layer interposed between the array substrate and the counter substrate.

This liquid crystal display device of the present invention further includes a signal output circuit which outputs display signals corresponding to display data to the drain lines; and a gate-scan driving circuit which sequentially scans the gate lines in every scanning frame period.

While having the above described constitution, this liquid crystal display device of the present invention includes at least two of the switching elements connected to a corresponding one of the pixel electrodes, which is arranged at an intersection of the i-th row (where i represents a positive integer) and the j-th column (where j represents a positive integer). In addition, in this liquid crystal display device of the present invention, the other terminal of a first switching element out of the two switching elements is connected to an odd-numbered one of the drain lines, which supplies first display signals of a positive polarity, and the other terminal of a second switching element out of the two switching elements is connected to an even-numbered one of the drain lines, which supplies second display signals of a negative polarity. Moreover, in this liquid crystal display device of the present invention, an odd-numbered one of the gate lines is connected to a control terminal of the first switching element, an even-numbered one of the gate lines is connected to a control terminal of the second switching element, the other terminal of the first switching element of the pixel electrode arranged at an intersection of the i-th row and the (j+1)-th column is connected to the even-numbered one of the drain lines, the other terminal of the second switching element thereof is connected to another odd-numbered one of the drain lines, the odd-numbered one of the gate lines is connected to a control terminal of this first switching element, and the even-numbered one of the gate lines is connected to a control terminal of this second switching element.

Additionally, the gate-scan driving circuit selectively drives the even-numbered ones of the gate lines and the odd-numbered ones of the gate lines, and thereby inverts directions of electric fields acting upon the liquid crystal layer without changing the polarities of the display signals.

Moreover, this liquid crystal display device of the present invention may assume a configuration by which switching signals are alternately applied to the first switching elements and to the second switching elements on a scanning frame to scanning frame basis, by using two of the gate lines with respect to each of the pixel electrodes, as means for switching the directions of the electric fields acting upon the liquid crystal layer.

Furthermore, the switching elements of this liquid crystal display device of the present invention may also each assume a structure that is a field effect transistor, and the field effect transistor of this liquid crystal display device of the present invention may also assume a structure that is a thin-film transistor.

Furthermore, this liquid crystal display device of the present invention may assume a vertical electric field mode or a horizontal electric field mode.

As has been described above, according to the present invention, as a first effect, a power consumption of the liquid crystal display device can be considerably reduced. Furthermore, as a second effect, reduction of delays of signal waveforms of the liquid crystal display device, and equalization of a distribution of in-plane write percentages in the liquid crystal display device in association with this reduction, become possible.

That is, one of the reasons why the aforementioned effects can be obtained is that: because the outputting polarities of signal wirings are not inverted, a charging current to the wirings can be considerably lessened, and as a result, the power consumption is reduced. The other reason is that: for the aforementioned reason, the signal delays in the liquid crystal display device can be reduced, whereby rise time of the signal waveforms is not delayed, and, in line with this reduction, equalization of the distribution of in-plane write percentages in the liquid crystal display device is promoted.

### BRIEF DESCRIPTION OF THE DRAWINGS

FIG. 1 is a diagram showing a conventional LCD device.

FIG. 2 is a chart explaining operations of the conventional LCD device.

FIG. 3 is a diagram showing a vertical electric field mode LCD device according to a first exemplary embodiment of the present invention.

FIG. 4 is a chart explaining operations of: the vertical electric field mode LCD device according to the first exemplary embodiment of the present invention; a first horizontal electric field mode LCD device according to a second exemplary embodiment of the present invention; and a second horizontal electric field mode LCD device according to a third exemplary embodiment of the present invention.

FIG. 5 is a cross-sectional view of the LCD device according to the first exemplary embodiment of the present invention.

FIG. 6 is a diagram showing the entirety of the LCD device according to the first exemplary embodiment of the present invention.

FIG. 7 is a diagram schematically showing a configuration of the first horizontal electric field mode LCD device according to the second exemplary embodiment of the present invention.

FIG. 8A is a diagram showing a one-pixel portion of the first horizontal electric field mode LCD device according to the second exemplary embodiment of the present invention.

FIG. 8B is a cross-sectional view obtained by cutting, along the I-I line, a structure of the one-pixel portion of the first horizontal electric field mode LCD device according to the second exemplary embodiment of the present invention.

FIG. 8C is a cross-sectional view schematically showing the structure of the one-pixel portion of the first horizontal electric field mode LCD device according to the second exemplary embodiment.

FIG. 9 is a diagram more minutely showing the configuration shown in FIG. 7 of the first horizontal electric field mode LCD device according to the second exemplary embodiment of the present invention.

FIG. 10 is a diagram schematically showing a configuration of the second horizontal electric field mode LCD device according to the third exemplary embodiment of the present invention.

FIG. 11A is a diagram showing a one-pixel portion of the second horizontal electric field mode LCD device according to the third exemplary embodiment of the present invention.

FIG. 11B is a cross-sectional view obtained by cutting, along the II-II line, a structure of the one-pixel portion of the second horizontal electric field mode LCD device according to the third exemplary embodiment of the present invention.

FIG. 11C is a cross-sectional view schematically showing the structure of the one-pixel portion of the second horizontal electric field mode LCD device according to the third exemplary embodiment.

FIG. 12 is a diagram more minutely showing the configuration shown in FIG. 10 of the second horizontal electric field mode LCD device according to the third exemplary embodiment of the present invention.

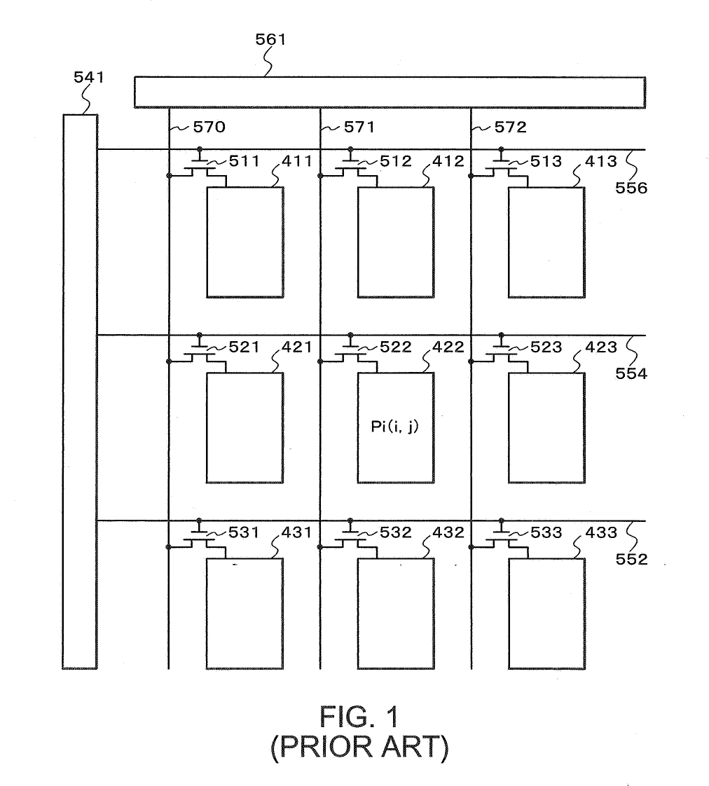

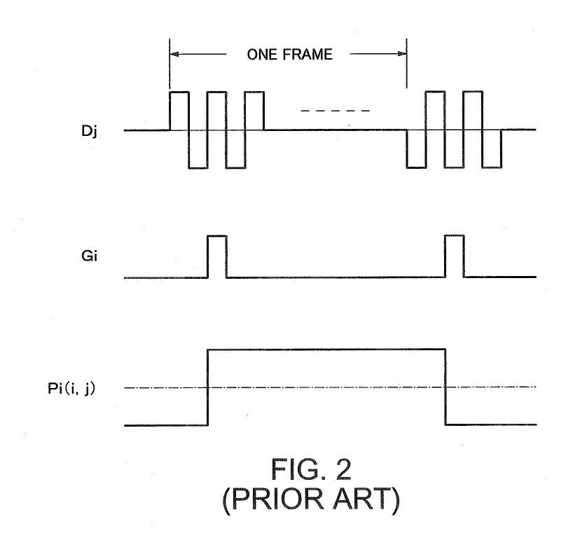

### DETAILED DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Next, the embodiments to which the present invention can be applied will be explained. The following explanation will explain the embodiments of the present invention, and the present invention is not limited by the following embodiments.

For clarification of the explanation, omission and simplification will be made as appropriate in the following description and drawings. Additionally, those skilled in the art will be able to easily make modifications, additions and alterations to each element of the following embodiments without departing from the scope of the present invention.

Note that elements denoted by the same reference numeral in each of the drawings indicate similar elements, and explanations thereon will be omitted as appropriate.

### A First Exemplary Embodiment of the Present Invention

Next, a configuration of an exemplary embodiment of the present invention will be explained in detail with reference to the drawings. Here, any one of LCD devices of the present invention is applied to a vertical electric field mode (TN (Twisted Nematic), VA (Vertical Alignment), OCB (Optically Compensated Birefringence) or the like) LCD device in which alignment of liquid crystal molecules is changed by an electric field between a plurality of electrodes provided on an array substrate and an electrode provided on a counter substrate.

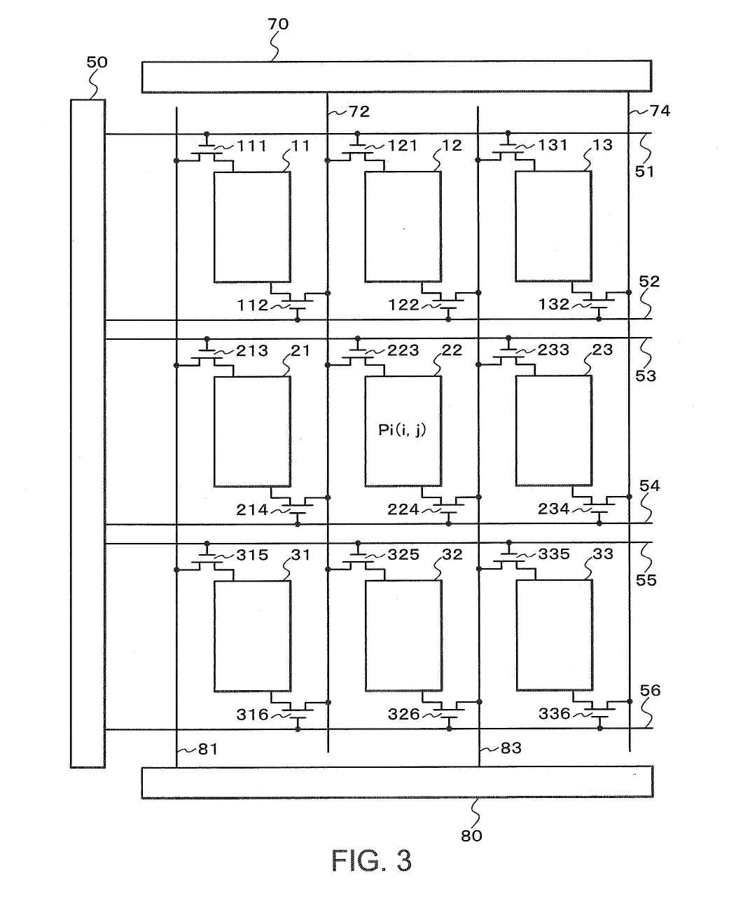

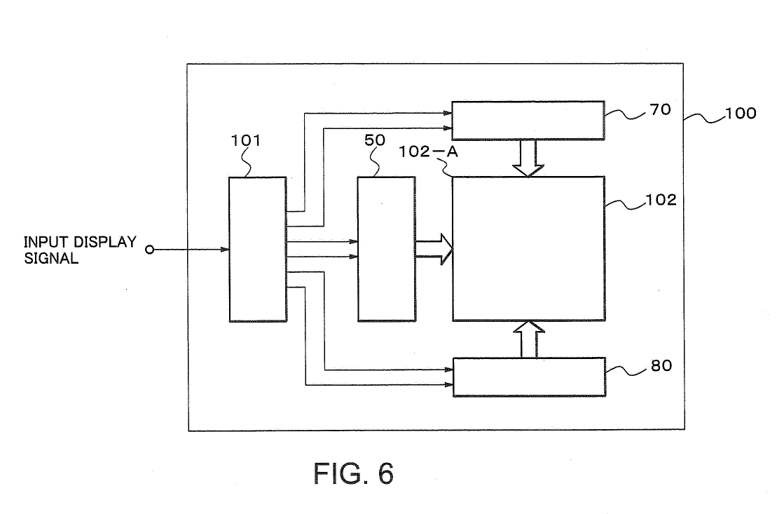

Referring to FIGS. 3 and 6, a LCD device 100 includes: pixel electrodes 11, 12, 13, 21, 22, 23, 31, 32 and 33 arranged on a display region 102 in a matrix; and TFTs respectively corresponding to switching elements at least two of which are provided to one pixel electrode in order to supply, through a display control circuit 101, input display signals corresponding to image data to the pixel electrodes.

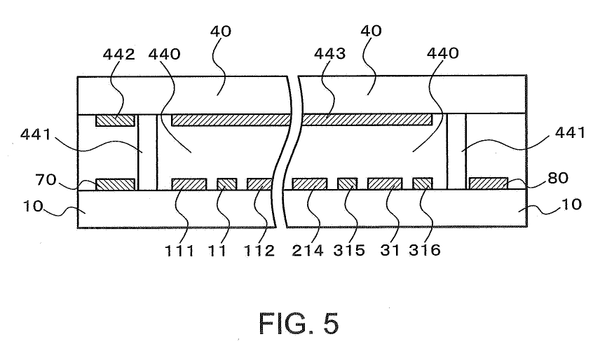

Furthermore, referring to FIG. 5 in addition, the LCD device 100 includes: an array substrate 10 on which the pixel electrodes 11, 12, 13, 21, 22, 23, 31, 32 and 33, and a plurality of pairs of TFTs 111 and 112, 121 and 122, 131 and 132, 213 and 214, 223 and 224, 233 and 234, 315 and 316, 325 and 326, and 335 and 336, are arranged in a matrix, the pairs of the TFTs being connected to the corresponding pixel electrodes 11, 12, 13, 21, 22, 23, 31, 32 and 33. Additionally, the LCD device 100 has a liquid crystal layer 440 interposed between the array substrate 10 and a counter substrate 40 having a common electrode 443 arranged thereon.

Note that, in order to number drain lines, alternate ones of the drain lines will be expressed, in a direction in which columns are arranged, as odd-numbered drain lines which are the first drain line, the third drain line, the fifth drain line, the seventh drain line, and so on by taking an upper left corner 102-A of the display region 102 shown in FIG. 6 as an origin.

Furthermore, the other alternate ones of the drain lines will be expressed sequentially as even-numbered drain lines which are the second drain line, the fourth drain line, the sixth drain line, the eighth drain line, and so on.

Furthermore, in order to number gate lines, the gate lines will be expressed, in expressions similar to those in the case of the drain lines, as odd-numbered gate lines and even-numbered gate lines, in a direction in which the rows are arranged, by taking the upper left corner 102-A of the display region 102 as an origin.

The array substrate 10 includes: an even-number signal output circuit 70 for supplying a display signal to each of the pixel electrodes through even-numbered drain lines 72 and 74; and an odd-number signal output circuit 80 for supplying a display signal to each of the pixel electrodes through odd-numbered drain lines 81 and 83.

In this description above, the even-number signal output circuit 70 and the odd-number signal output circuit 80 are disposed on another side respectively around each of the pixel electrodes on the array substrate 10. The even number-signal output circuit 70 and the odd-number signal output circuit 80 also can be disposed on the same side around each of the pixel electrodes on the array substrate 10.

Furthermore, the array substrate 10 includes a gate-scan driving circuit 50 for supplying a signal, which controls ON and OFF states of each of the TFTs, through odd-numbered gate lines 51, 53 and 55 and even-numbered gate lines 52, 54 and 56.

That is, by having the liquid crystal layer 440 interposed between the array substrate 10 and the counter substrate 40 which has the common electrode 443 arranged thereon, the LCD device 100 modulates an intensity of light, which is made incident on the liquid crystal layer, by transmission, scattering, absorption, birefringence or the like with respect to each pixel, and thereby performs display.

A source and a drain of each of the TFTs 111, 121, 131, 213, 223, 233, 315, 325 and 335 connected to a corresponding one of the odd-numbered gate lines 51, 53 and 55 are inserted between a corresponding one of the signal lines 81, 72 and 83 and a corresponding one of the pixel electrodes 11, 12, 13, 21, 22, 23, 31, 32 and 33.

Additionally, a source and a drain of each of the TFTs 112, 122, 132, 214, 224, 234, 316, 326 and 336 connected to a corresponding one of the even-numbered gate lines 52, 54 and 56 are inserted between a corresponding one of the signal lines 72, 83 and 74 and a corresponding one of the pixel electrodes 11, 12, 13, 21, 22, 23, 31, 32 and 33.

Consequently, ON and OFF states of the TFTs 111, 121, 131, 213, 223, 233, 315, 325 and 335 are controlled by a scanning signal applied to the odd-numbered gate lines 51, 53 and 55.

When the TFTs 111, 121, 131, 213, 223, 233, 315, 325 and 335 are turned ON, a display signal supplied to the respective signal lines 81, 72 and 83 is selected to be applied to the pixel electrodes 11, 12, 13, 21, 22, 23, 31, 32 and 33.

Similarly, ON and OFF states of the TFTs 112, 122, 132, 214, 224, 234, 316, 326 and 336 are controlled by a scanning signal applied to the even-numbered gate lines 52, 54 and 56.

When the TFTs 112, 122, 132, 214, 224, 234, 316, 326 and 336 are turned ON, a display signal supplied to the respective signal lines 72, 83 and 74 is selected to be applied to the pixel electrodes 11, 12, 13, 21, 22, 23, 31, 32 and 33.

Next, operations of the first exemplary embodiment of the present invention will be explained in detail with reference to the drawings. Here, the pixel electrodes will be explained by explaining a pixel electrode 11 and a pixel electrode 12 as representatives thereof.

The LCD device of the first exemplary embodiment of the present invention has the two TFTs 111 and 112 with respect to the single pixel electrode 11. The drain (or source) of the TFT 111 is connected to the odd-numbered signal line 81 to the left of the pixel electrode 11. Additionally, a gate of the TFT 111 is connected to the odd-numbered gate line 51 located above the pixel electrode 11.

Similarly, the drain (or source) of the TFT 112 is connected to the even-numbered signal line 72 to the right of the pixel electrode 11. Additionally, a gate of the TFT 112 is connected to the even-numbered gate line 52 located below the pixel electrode 11.

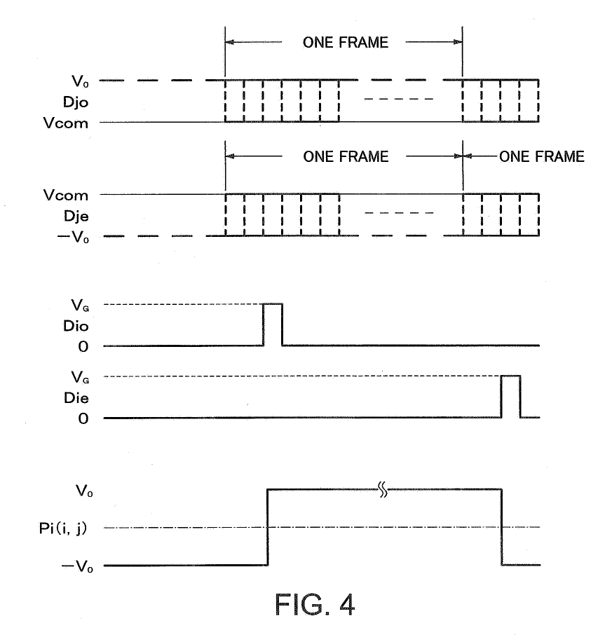

Referring to FIG. 4 in addition, the TFT 111 receives, in one frame period, a signal Djo (V0) supplied to the odd-numbered signal line 81 to the left of the pixel electrode 11, and a signal Gio supplied to the odd-numbered gate line 51 located above the pixel electrode 11, and thereby applies a voltage to the pixel electrode 11. Here, the suffix “o” for these signals is a mark representing an odd number.

Similarly, the drain (or source) of the TFT 112 is connected to the even-numbered signal line 72 to the right of the pixel electrode 11. Additionally, the gate of the TFT 112 is connected to the signal line 52 located below the pixel electrode 11.

The TFT 112 receives, in one frame period following the foregoing one frame period, a signal Dje (−V0) supplied to the even-numbered signal line 72 to the right of the pixel electrode 11, and a signal Gie supplied to the even-numbered gate line 52 located above the pixel electrode 11, and thereby applies a voltage to the pixel electrode 11. Here, the suffix “e” for these signals is a mark representing an even number.

That is, two gate lines are arranged to the pixel electrodes in each of the columns, an ON voltage is supplied only to any one of the two gate lines in an ON operation in every frame, and this operation is alternately performed on the two gate lines.

With the abovementioned structure, a signal voltage (having a positive polarity) of the signal Djo to the left of the pixel electrode is applied to the pixel electrode in a frame where the signal Gio, which is supplied to the odd-numbered gate line, operates. In contrast, a signal voltage (having a negative polarity) of the signal Dje to the right of the pixel electrode is applied to the pixel electrode in a frame where the signal Gie, which is supplied to the even-numbered gate line, operates.

Next, connections and operations of the pixel electrode 12 located to the close right of the pixel electrode 11 will be explained.

The pixel electrode 12 has two TFTs 121 and 122. The drain (or source) of the TFT 121 is connected to the even-numbered signal line 72 to the left of the pixel electrode 12. Additionally, a gate of the TFT 121 is connected to the odd-numbered gate line 51 located above the pixel electrode 12.

Similarly, the drain (or source) of the TFT 122 is connected to the odd-numbered signal line 83 to the right of the pixel electrode 12. Additionally, a gate of the TFT 122 is connected to the even-numbered gate line 52 located below the pixel electrode 12.

Referring to FIG. 4 in addition, the TFT 121 receives, in a one-frame period, the signal Dje supplied to the even-numbered signal line 72 to the left of the pixel electrode 12, and the signal Gio supplied to the odd-numbered gate line 51 located above the pixel electrode 12, and thereby applies a voltage to the pixel electrode 12.

Similarly, the drain (or source) of the TFT 122 is connected to the odd-numbered signal line 83 to the right of the pixel electrode 12. Additionally, the gate of the TFT 122 is connected to the signal line 52 located below the pixel electrode 12.

The TFT 122 receives, in one frame period following the foregoing one frame period, the signal Djo (V0) supplied to the signal line 83 to the right of the pixel electrode 12, and the signal Gie supplied to the even-numbered gate line 52 located above the pixel electrode 12, and thereby applies a voltage (V0) to the pixel electrode 12.

With the abovementioned structure, the signal voltage (having the negative polarity) of the signal Dje to the left of the pixel electrode is applied to the pixel electrode in a frame where the signal Gio, which is supplied to the odd-numbered gate line, operates. In contrast, the signal voltage (having the positive polarity) of the signal Djo to the right of the pixel electrode is applied to the pixel electrode in a frame where the signal Gie, which is supplied to the even-numbered gate line, operates.

That is, when the signal Djo of the odd-numbered signal line 81 to the left of the pixel electrode 11 is selected, the signal Dje of the signal line 72 to the right of the pixel electrode 11 functions as a signal of a signal line of the pixel electrode 12, i.e., a signal D(j+1)o.

Here, any one of the pixel electrode is expressed as a general pixel electrode Pi (i, j), and a pixel electrode to the close right of the pixel electrode Pi(i,j) is expressed as a pixel electrode Pi(i,j+1). That is, when the signal Djo to the left of the pixel electrode Pi(i,j) is selected, the signal Dje of the signal line to the right of the pixel electrode Pi(i,j) functions as the signal D(j+1)o of the signal line to the left of the pixel electrode Pi(i,j+1).

Alternate ones of the signal wirings supply a voltage of the positive polarity, and the other alternate ones thereof supply a voltage of the negative polarity. The voltages are outputted constantly without inverting the relative polarities to a common voltage.

Referring again to FIG. 5, this LCD device is constituted of: the counter substrate 40 including the common electrode 443, and a common-electrode driving circuit 442 which drives the common electrode 443; and the liquid crystal layer 440 interposed between the pair of substrates. Additionally, sealing member 441, which seals the liquid crystal layer 440, is also arranged in this LCD device.

The common electrode 443 can be formed of, for example, a transparent conductive material such as ITO (Indium Tin Oxide).

In this LCD device, a channel semiconductor layer of each of the TFTs is formed by using polycrystalline silicon such as poly-Si.

Additionally, any one of the LCD devices of the present invention can assume a configuration where the LCD device is applied to the vertical electric field mode (TN (Twisted Nematic), VA (Vertical Alignment), OCB (Optically Compensated Birefringence) or the like) LCD device in which alignment of liquid crystal molecules can be changed by an electric field between each of a plurality of electrodes provided on the array substrate and the counter substrate.

According to the LCD device of this exemplary embodiment, two TFTs are connected to a single pixel electrode, whereby a display signal constantly having a positive polarity, and a display signal constantly having a negative polarity are alternately written, respectively through these different transistors, into this single pixel electrode. Because the output polarities of the display signals of the signal lines are not inverted, a charging current to wirings can be considerably lessened, and as a result, a power consumption can be reduced.

Thereby, considerable reduction in power consumption of the vertical electric field mode LCD device is realized. Furthermore, because the output polarities of the display signals of the signal lines are not inverted, signal delay of the display signals of the signal lines are reduced, whereby rise time of the waveforms is not delayed, and delays of the signal waveforms can be reduced. In line with this, equalization of a distribution of in-plane write percentages in the vertical electric field mode LCD device can be promoted.

### A Second Exemplary Embodiment of the Present Invention

Next, a case will be explained in which any one of LCD devices of the present invention is applied to, for example, a LCD device of a horizontal electric field mode (IPS (In-plain Switching)). In the horizontal electric field mode, alignment of liquid crystal molecules can be changed by an electric field between each of a plurality of electrodes provided on an array substrate.

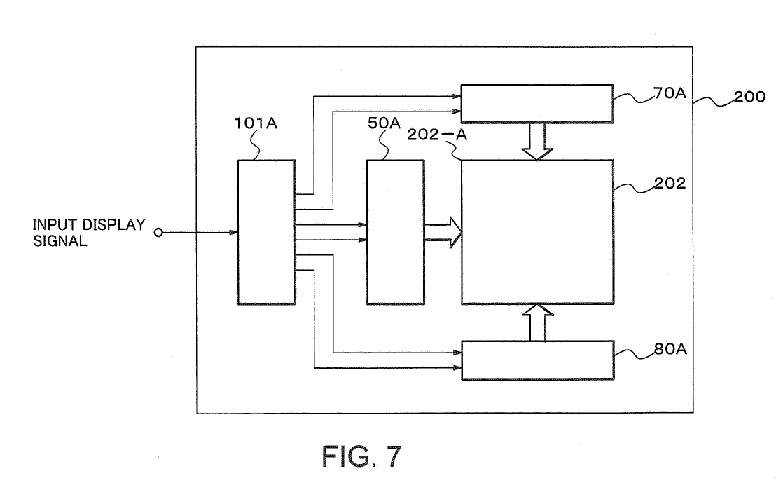

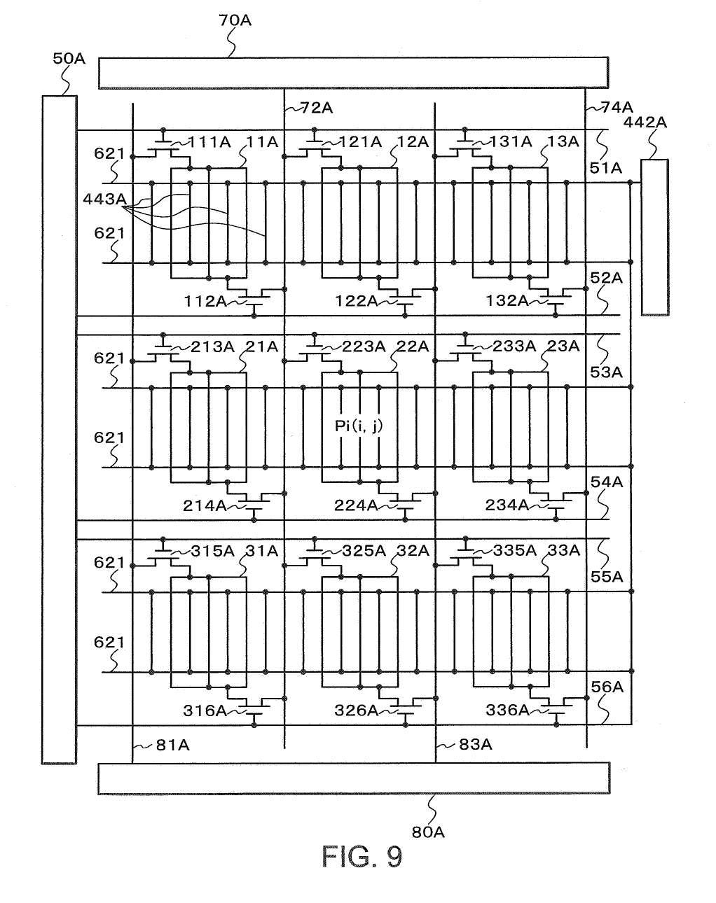

Referring to FIGS. 7 and 9, the first horizontal electric field mode LCD device 200 includes: pixel electrodes Pi(i,j) 11A, 12A, 13A, 21A, 22A, 23A, 31A, 32A and 33A arranged on a display region 202 in a matrix; and TFTs respectively corresponding to switching elements at least two of which are provided to one pixel electrode in order to supply, through a display control circuit 101A, input display signals corresponding to image data.

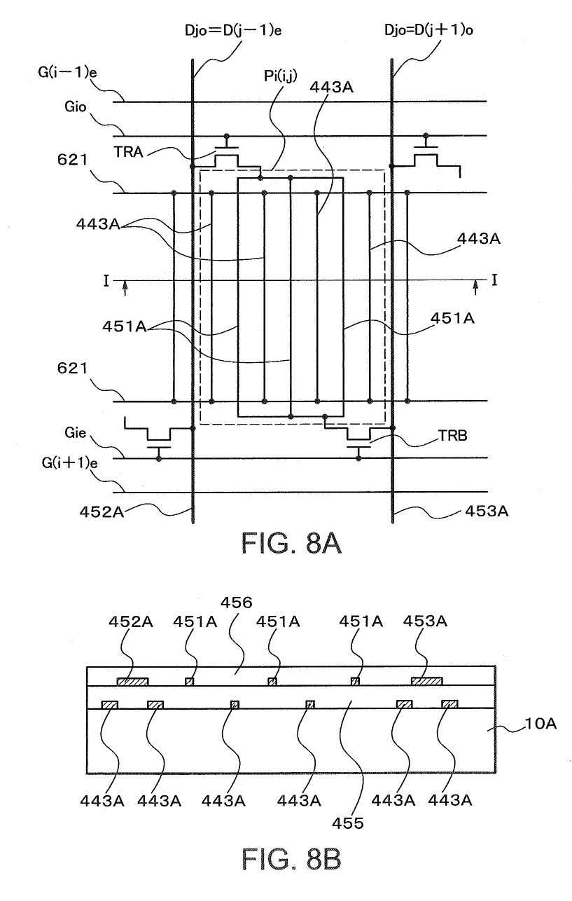

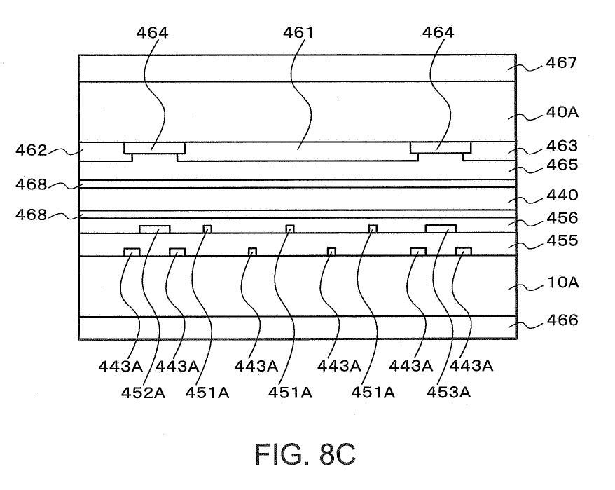

Furthermore, referring to FIGS. 8A to 8C in addition, the first horizontal electric field mode LCD device 200 includes an array substrate 10A constituted of a glass substrate on which: the pixel electrodes 12A, 12A, 13A, 21A, 22A, 23A, 31A, 32A and 33A, and a plurality of pairs of TFTs 111A and 112A, 121A and 122A, 131A and 132A, 213A and 214A, 223A and 224A, 233A and 234A, 315A and 316A, 325A and 326A, and 335A and 336A, are arranged in a matrix, the respective pairs of the TFTs being connected to the respective pixel electrodes 11A, 12A, 13A, 21A, 22A, 23A, 31A, 32A and 33A.

Moreover, the first horizontal electric field mode LCD device 200 has common electrodes 443A arranged on the array substrate 10A constituted of the glass substrate, and these common electrodes 443A are covered with a gate insulating film 455. Furthermore, the LCD device 200 has pixel electrodes 451A and drain lines 452A and 453A arranged on the gate insulating film 455, and these pixel electrode 451 and drain lines 452A and 453A are covered with a passivation film 456 and an alignment layer 468 as shown in FIG. 8C.

Furthermore, the LCD device 200 includes a counter substrate 40A constituted of a color filter glass substrate. Moreover, a color layer (red) 461, a color layer (blue) 462, a color layer (green) 463 and a black matrix 464 are respectively deposited on the counter substrate 40A constituted of the color filter glass substrate as shown in FIG. 8C. Additionally, the color layer (red) 461, the color layer (blue) 462, the color layer (green) 463 and the black matrix 464 are respectively covered with an overcoat material 465 and an alignment layer 468. The LCD device 200 has the liquid crystal layer 440 interposed between the array substrate 10A constituted of the glass substrate, and the counter substrate 40A constituted of the color filter glass substrate as shown in FIG. 8C.

Furthermore, the first horizontal electric field mode LCD device 200 includes a polarizing plate 466 on the other surface of the array substrate 10A constituted of the glass substrate. Additionally, the first horizontal electric field mode LCD device 200 includes a polarizing plate 467 on the other surface of the counter substrate 40A constituted of the color filter glass substrate as shown in FIG. 8C.

Note that, as in the case with the first exemplary embodiment, in order to number drain lines, alternate ones of the drain lines will be expressed, sequentially in a direction of columns from an upper left corner 202-A of the display region 202 shown in FIG. 7, in a direction in which columns are arranged, as odd-numbered drain lines which are the first drain line, the third drain line, the fifth drain line, the seventh drain line, and so on.

Furthermore, the other alternate ones of the drain lines will be expressed sequentially as even-numbered drain lines which are the second drain line, the fourth drain line, the sixth drain line, the eighth drain line, and so on.

Furthermore, in order to number gate lines, the gate lines are expressed, in expressions similar to those in the case of the drain lines, as odd-numbered gate lines and even-numbered gate lines sequentially from the upper left corner 202-A of the display region 202 in a direction in which rows are arranged.

The array substrate 10A includes: an even-number signal output circuit 70A for supplying a display signal to each of the pixel electrodes through even-numbered drain lines 72A and 74A; and an odd-number signal output circuit 80A for supplying a display signal to each of the pixel electrodes through odd-numbered drain lines 81A and 83A.

In this description above, the even-number signal output circuit 70A and the odd-number signal output circuit 80A are disposed on another side respectively around each of the pixel electrodes on the array substrate 10A. The even number-signal output circuit 70A and the odd-number signal output circuit 80A also can be disposed on the same side around each of the pixel electrodes on the array substrate 10A.

Furthermore, the array substrate 10A includes a gate-scan driving circuit 50A for supplying a signal, which controls ON and OFF states of each of the TFTs, through odd-numbered gate lines 51A, 53A and 55A and even-numbered gate lines 52A, 54A and 56A.

That is, by having the liquid crystal layer 440 interposed between the array substrate 10A and the counter substrate 40A, the LCD device 200 modulates an intensity of light, which is made incident on the liquid crystal layer, by transmission, scattering, absorption, birefringence or the like with respect to each pixel, and thereby performs display.

A source and a drain of each of the TFTs 11A, 121A, 131A, 213A, 223A, 233A, 315A, 325A and 335A connected to a corresponding one of the odd-numbered gate line 51A, 53A and 55A are inserted between a corresponding one of the signal lines 81A, 72A and 83A and a corresponding one of the pixel electrodes 11A, 12A, 13A, 21A, 22A, 23A, 31A, 32A and 33A.

Additionally, a source and a drain of each of the TFTs 112A, 122A, 132A, 214A, 224A, 234A, 316A, 326A and 336A connected to a corresponding one of the even-numbered gate lines 52A, 54A and 56A are inserted between a corresponding one of the signal lines 72A, 83A and 74A and a corresponding one of the pixel electrodes 11A, 12A, 13A, 21A, 22A, 23A, 31A, 32A and 33A.

Consequently, ON and OFF states of the TFTs 11A, 121A, 131A, 213A, 223A, 233A, 315A, 325A and 335A are controlled by a scanning signal applied to the odd-numbered gate lines 51A, 53A and 55A.

When the TFTs 11A, 121A, 131A, 213A, 223A, 233A, 315A, 325A and 335A are turned ON, a display signal supplied to the respective signal lines 81A, 72A and 83A is selected to be applied to the pixel electrodes 11A, 12A, 13A, 21A, 22A, 23A, 31A, 32A and 33A.

Similarly, ON and OFF states of the TFTs 112A, 122A, 132A, 214A, 224A, 234A, 316A, 326A and 336A are controlled by a scanning signal applied to the even-numbered gate lines 52A, 54A and 56A.

When the TFTs 112A, 122A, 132A, 214A, 224A, 234A, 316A, 326A and 336A are turned ON, a display signal supplied to the respective signal lines 72A, 83A and 74A is selected to be applied to the pixel electrodes 11A, 12A, 13A, 21A, 22A, 23A, 31A, 32A and 33A.

In addition, the first horizontal electric field mode LCD device 200 according to this second exemplary embodiment includes the common electrodes 443A and common wirings 621, and further includes a common electrode driving circuit 442A which drives the common electrodes 443A through the common wirings 621.

Next, operations of the first horizontal electric field mode LCD device of the present invention will be explained in detail with reference to the drawings. Here, the pixel electrodes will be explained by explaining a pixel electrode 11A and a pixel electrode 12A as representatives thereof.

The first horizontal electric field mode LCD device 200 of the present invention has two TFTs 111A and 112A with respect to the single pixel electrode 11A. The drain (or source) of the TFT 11A is connected to the odd-numbered signal line 81A to the left of the pixel electrode 11A. Additionally, a gate of the TFT 111A is connected to the odd-numbered gate line 51A located above the pixel electrode 11A.

Similarly, the drain (or source) of the TFT 112A is connected to the even-numbered signal line 72A to the right of the pixel electrode 111A. Additionally, a gate of the TFT 112A is connected to the even-numbered gate line 52A located below the pixel electrode 11A.

Referring to FIG. 4 in addition, the TFT 111A receives, in one frame period, a signal Djo (V0) supplied to the odd-numbered signal line 81A to the left of the pixel electrode 11A, and a signal Gio supplied to the odd-numbered gate line 51A located above the pixel electrode 11A, and thereby applies a voltage to the pixel electrode 11A. Here, the suffix “o” for these signals is a mark representing an odd number.

Similarly, the drain (or source) of the TFT 112A is connected to the even-numbered signal line 72A to the right of the pixel electrode 11A. Additionally, the gate of the TFT 112A is connected to the signal line 52A located below the pixel electrode 11A.

The TFT 112A receives, in one frame period following the foregoing one frame period, a signal Dje (−V0) supplied to the even-numbered signal line 72A to the right of the pixel electrode 11A, and a signal Gie supplied to the even-numbered gate line 52A located above the pixel electrode 11A, and thereby applies a voltage to the pixel electrode 11A. Here, the suffix “e” for these signals is a mark representing an even number.

That is, two gate lines are arranged to the pixel electrodes in each of the columns, an ON voltage is supplied only to any one of the two gate lines in an ON operation in every frame, and this operation is alternately performed on the two gate lines.

With the abovementioned structure, a signal voltage (having a positive polarity) of the signal Djo to the left of the pixel electrode is applied to the pixel electrode in a frame where the signal Gio, which is supplied to the odd-numbered gate line, operates. In contrast, a signal voltage (having a negative polarity) of the signal Dje to the right of the pixel electrode is applied to the pixel electrode in a frame where the signal Gie, which is supplied to the even-numbered gate line, operates.

Next, connections and operations of the pixel electrode 12A located to the close right of the pixel electrode 11A will be explained.

The pixel electrode 12A has two TFTs 121A and 122A. The drain (or source) of the TFT 121A is connected to the even-numbered signal line 72A to the left of the pixel electrode 12A. Additionally, a gate of the TFT 121A is connected to the odd-numbered gate line 51A located above the pixel electrode 12A.

Similarly, the drain (or source) of the TFT 122A is connected to the odd-numbered signal line 83A to the right of the pixel electrode 12A. Additionally, a gate of the TFT 122A is connected to the even-numbered gate line 52A located below the pixel electrode 12A.

Referring to FIG. 4 in addition, the TFT 121A receives, in one frame period, the signal Dje supplied to the even-numbered signal line 72A to the left of the pixel electrode 12A, and the signal Gio supplied to the odd-numbered gate line 51A located above the pixel electrode 12A, and thereby applies a voltage to the pixel electrode 12A.

Similarly, the drain (or source) of the TFT 122A is connected to the odd-numbered signal line 83A to the right of the pixel electrode 12A. Additionally, the gate of the TFT 122A is connected to the signal line 52A located below the pixel electrode 12A.

The TFT 122A receives, in one frame period following the foregoing one frame period, the signal Djo (V0) supplied to the signal line 83A to the right of the pixel electrode 12A, and the signal Gie supplied to the even-numbered gate line 52A located below the pixel electrode 12A, and thereby applies a voltage (V0) to the pixel electrode 12A.

With the abovementioned structure, the signal voltage (having the negative polarity) of the signal Dje to the left of the pixel electrode is applied to the pixel electrode in a frame where the signal Gio, which is supplied to the odd-numbered gate line, operates. In contrast, the signal voltage (having the positive polarity) of the signal Djo to the right of the pixel electrode is applied to the pixel electrode in a frame where the signal Gie, which is supplied to the even-numbered gate line, operates.

That is, when the signal Djo of the odd-numbered signal line 81A to the left of the pixel electrode 11A is selected, the signal Dje of the signal line 72A to the right of the pixel electrode 11A functions as a signal of a signal line of the pixel electrode 12, i.e., a signal D(j+1)o.

Here, any one of the pixel electrode is expressed as a general pixel electrode Pi(i,j), and a pixel electrode to the close right of the pixel electrode Pi(i,j) is expressed as a pixel electrode Pi(i,j+1). That is, when the signal Djo to the left of the pixel electrode Pi(i,j) is selected, the signal Dje to the right of the pixel electrode Pi j(i,j) functions as the signal D(j+1)o of the signal line to the left of the pixel electrode Pi(i,j+1).

Alternate ones of the signal wirings supply a voltage of the positive polarity, and the other alternate ones thereof supply a voltage of the negative polarity. The voltages are outputted without inverting the polarities to a common voltage.

As has been described hereinabove, according to the first horizontal electric field mode LCD device of the second exemplary embodiment of the present invention, the output polarities of the display signals of the signal lines are not inverted as in the case with the first exemplary embodiment of the present invention. For this reason, a charging current to wirings can be considerably lessened, and as a result, a power consumption can be reduced. As a result, a power consumption can be considerably reduced in the horizontal electric field mode LCD device.

Furthermore, because the output polarities of the display signals of the signal lines are not inverted, signal delays of the display signals of the signal lines can be reduced, whereby rise time of signal waveforms is not delayed, and reduction of delays of the signal waveforms is realized.

### A Third Exemplary Embodiment of the Present Invention

Next, a case will be explained in which the LCD device of the present invention is applied to a LCD device of a horizontal electric field mode (IPS (In-plain Switching)) similar to the one of the second exemplary embodiment.

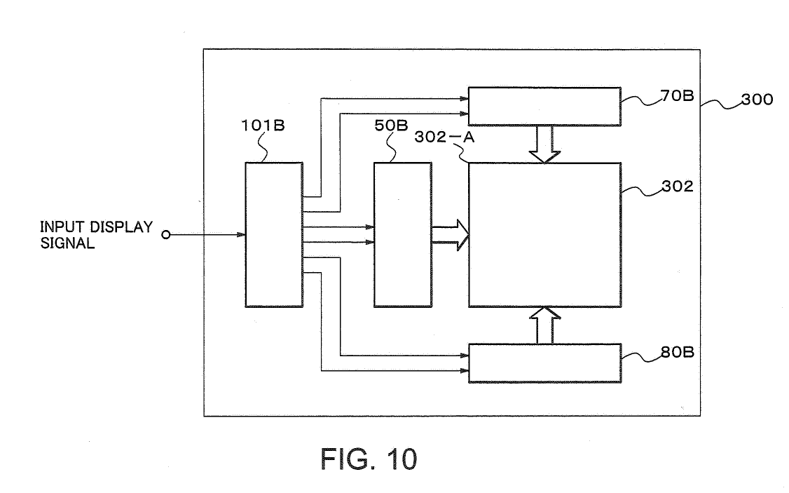

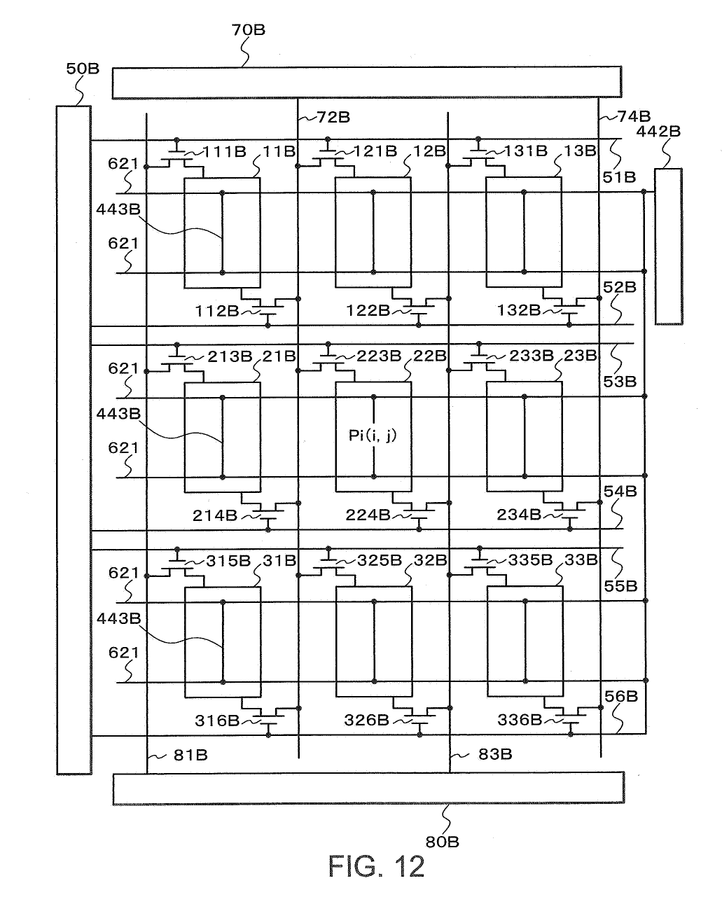

Here, referring to FIGS. 10 and 12, this second horizontal electric field mode LCD device 300 includes: pixel electrodes Pi(i,j) 11B, 12B, 13B, 21B, 22B, 23B, 31B, 32B and 33B arranged on a display region 302 in a matrix; and TFTs respectively corresponding to switching elements at least two of which are provided to one pixel electrode in order to supply, through a display control circuit 101B, input display signals corresponding to image data.

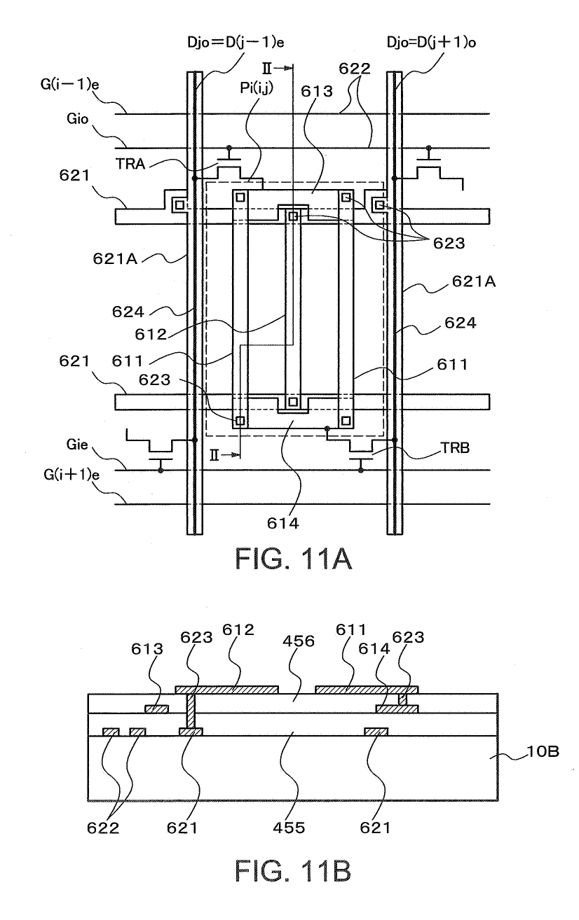

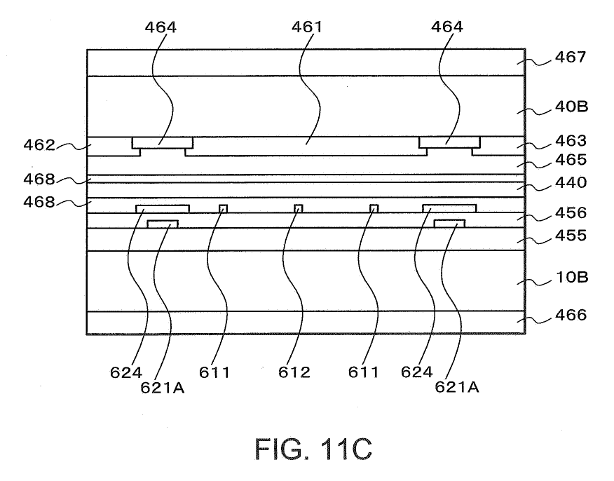

Furthermore, referring to FIGS. 11A to 11C in addition, the second horizontal electric field mode LCD device 300 includes an array substrate 10B constituted of a glass substrate on which: the pixel electrodes 11B, 12B, 13B, 21B, 22B, 23B, 31B, 32B and 33B, and a plurality of pairs of TFTs 111B and 112B, 121B and 122B, 131B and 132B, 213B and 214B, 223B and 224B, 233B and 234B, 315B and 316B, 325B and 326B, and 335B and 336B, are arranged in a matrix, the pairs of the TFTs being connected to the respective pixel electrodes 11B, 12B, 13B, 21B, 22B, 23B, 31B, 32B and 33B. Moreover, the second horizontal electric field mode LCD device 300 includes common electrodes 443B and the common wirings 621, and further includes a common electrode driving circuit 442B which drives the common electrodes 443B through the common wirings 621.

Furthermore, the second horizontal electric field mode LCD device 300 has the common wirings 621 and gate wirings 622 arranged on the array substrate 10B, and the common wirings 621 and the gate wirings 622 are covered with a gate insulating film 455 as shown in FIG. 11B.

Additionally, the second horizontal electric field mode LCD device 300 has pixel electrodes 613 and 614 arranged on the gate insulating film 455, and the pixel electrodes 613 and 614 are covered with a passivation film 456 as shown in FIG. 11B.

Additionally, in the second horizontal electric field mode LCD device 300, transparent electrode wirings 612 and 624 for common electrodes arranged on the passivation film 456 are formed extending from the common wirings 621 through contact holes 623 as shown in FIG. 11B. Moreover, in the second horizontal electric field mode LCD device 300, transparent electrode wirings 611 for are formed extending from the pixel electrodes 613 and 614 arranged on the passivation film 456 through the contact holes 623 as shown in FIG. 11B.

Furthermore, the LCD device 300 includes a counter substrate 40B constituted of a color filter glass substrate as shown in FIG. 11C. Moreover, a color layer (red) 461, a color layer (blue) 462, a color layer (green) 463 and a black matrix 464 are respectively deposited on the counter substrate 40B constituted of the color filter glass substrate. Additionally, the color layer (red) 461, the color layer (blue) 462, the color layer (green) 463 and the black matrix 464 are respectively covered with an overcoat material 465 and an alignment layer 468 as shown in FIG. 11C. And also transparent electrode wirings 611 are respectively covered with an alignment layer 468.

Additionally, the second horizontal electric field mode LCD device 300 has a liquid crystal layer 440 interposed between the array substrate 10B and the counter substrate 40B as shown in FIG. 11C.

That is, the second horizontal electric field mode LCD device and the first horizontal electric field mode LCD device are different only in the constitutions of the one-pixel portions of the respective devices, and the other constituent elements of the second horizontal electric field mode LCD device are the same as those of the first horizontal electric field mode LCD. Therefore, explanations on the other constituent elements of the second horizontal electric field mode LCD device will be omitted.

Similarly, operations of the second horizontal electric field mode LCD device are the same as the operations of the first horizontal electric field mode LCD device, and accordingly, explanations thereon will be omitted.

As has been described hereinabove, according to the second horizontal electric field mode LCD device of the third exemplary embodiment of the present invention, the output polarities of the display signals of the signal lines are not inverted as in the case with the first and second exemplary embodiments of the present invention. For this reason, a charging current to wirings can be considerably lessened, and as a result, a power consumption can be reduced.

Furthermore, because the output polarities of the display signals of the signal lines are not inverted, signal delays of the display signals of the signal lines can be reduced, whereby rise time of signal waveforms is not delayed, and reduction of delays of the signal waveforms is realized.

Although the present invention has been explained in association with the suitable embodiments, it can be understood that these embodiments have been presented only for the purpose of explaining the invention by listing practical examples, and are not intended to limit the invention.

After reading this description, it will become apparent to those skilled in the art that numerous changes and replacements can be easily made by using constituent elements and technologies which are equivalent for those skilled in the art. Nevertheless, it is apparent that such changes and replacements fall within the true scope and spirit of the appended claims.

It is apparent that the present invention is not limited to the above embodiments, but may be modified and changed without departing from the scope and spirit of the invention.

What is claimed is:

1. A liquid crystal display device comprising:
a plurality of drain lines;
a plurality of gate lines intersecting the drain lines;
switching elements formed in vicinities of corresponding ones of intersections of the drain lines and the gate lines;
an array substrate including pixel electrodes and a pixel region constituted of the pixel electrodes, the pixel electrodes being arranged in a matrix, and each of the pixel electrodes being connected to one of the two terminals of each of the switching elements;
a counter substrate placed to face the array substrate;
a liquid crystal layer interposed between the array substrate and the counter substrate;
a signal output circuit which outputs display signals corresponding to display data to the drain lines; and
a gate-scan driving circuit which sequentially scans the gate lines in every scanning frame period, wherein
at least two of the switching elements are connected to each of the pixel electrodes,
the other terminal of a first switching element out of the two switching elements is connected to an odd-numbered one of the drain lines, which supplies first display signals having a positive polarity,
the other terminal of a second switching element out of the two switching elements is connected to an even-numbered one of the drain lines, which supplies second display signals having a negative polarity,
an odd-numbered one of the gate lines is connected to a control terminal of the first switching element,
an even-numbered one of the gate lines is connected to a control terminal of the second switching element, and
the gate-scan driving circuit selectively drives odd-numbered ones of the gate lines and even-numbered ones of the gate lines, and thereby inverts directions of electric fields acting upon the liquid crystal layer without changing the polarities of the display signals.

2. A liquid crystal display device comprising:
a plurality of drain lines;
a plurality of gate lines intersecting the drain lines;
switching elements formed in vicinities of corresponding ones of intersections of the drain lines and the gate lines;
an array substrate including pixel electrodes and a pixel region constituted of the pixel electrodes, the pixel electrodes being arranged in a matrix of m rows (where m represents a positive integer) and n columns (where n represents a positive integer), and each of the pixel electrodes being connected to one of the two terminals of each of the switching elements;
a liquid crystal layer interposed between the array substrate and the counter substrate;
a signal output circuit which outputs display signals corresponding to display data to the drain lines; and
a gate-scan driving circuit which sequentially scans the gate lines in every scanning frame period, wherein
at least two of the switching elements are connected to a corresponding one of the pixel electrodes, which is arranged at an intersection of the i-th row (where i represents a positive integer) and the j-th column (where j represents a positive integer),
the other terminal of a first switching element out of the two switching elements is connected to an odd-numbered one of the drain lines, which supplies first display signals of a positive polarity,
the other terminal of a second switching element out of the two switching elements is connected to an even-numbered one of the drain lines, which supplies second display signals of a negative polarity,
an odd-numbered one of the gate lines is connected to a control terminal of the first switching element,
an even-numbered one of the gate lines is connected to a control terminal of the second switching element,
the other terminal of the first switching element of the pixel electrode arranged at an intersection of the i-th row and the (j+1)-th column is connected to the even-numbered one of the drain lines,
the other terminal of the second switching element thereof is connected to another odd-numbered one of the drain lines,
the odd-numbered one of the gate lines is connected to a control terminal of the first switching element,
the even-numbered one of the gate lines is connected to a control terminal of the second switching element, and
the gate-scan driving circuit selectively drives the even-numbered ones of the gate lines and the odd-numbered ones of the gate lines, and thereby inverts directions of electric fields acting upon the liquid crystal layer without changing the polarities of the display signals.

3. The liquid crystal display device as recited in claim 1, wherein switching signals are alternately applied to the first switching elements and to the second switching elements on a scanning frame to scanning frame basis, by using two of the gate lines with respect to each of the pixel electrodes, as means for switching the directions of the electric fields acting upon the liquid crystal layer.

4. The liquid crystal display device as recited in claim 2, wherein switching signals are alternately applied to the first switching elements and to the second switching elements on a scanning frame to scanning frame basis, by using two of the gate lines with respect to each of the pixel electrodes, as means for switching the directions of the electric fields acting upon the liquid crystal layer.

5. The liquid crystal display device as recited in claim 1, wherein each of the switching elements is a field effect transistor.

6. The liquid crystal display device as recited in claim 2, wherein each of the switching elements is a field effect transistor.

7. The liquid crystal display device as recited in claim 3, wherein each of the switching elements is a field effect transistor.

8. The liquid crystal display device as recited in claim 4, wherein each of the switching elements is a field effect transistor.

9. The liquid crystal display device as recited in claim 5, wherein the field effect transistor is a thin-film transistor.

10. The liquid crystal display device as recited in claim 6, wherein the field effect transistor is a thin-film transistor.

11. The liquid crystal display device as recited in claim 7, wherein the field effect transistor is a thin-film transistor.

12. The liquid crystal display device as recited in claim 8, wherein the field effect transistor is a thin-film transistor.

13. The liquid crystal display device as recited in claim 1, wherein the liquid crystal display device assumes a vertical electric field mode.

14. The liquid crystal display device as recited in claim 2, wherein the liquid crystal display device assumes a vertical electric field mode.

15. The liquid crystal display device as recited in claim 1, wherein the liquid crystal display device assumes a horizontal electric field mode.

16. The liquid crystal display device as recited in claim 2, wherein the liquid crystal display device assumes a horizontal electric field mode.
